(19) United States
(12) Patent Application Publication
(10) Pub. No.: US 2022/0234520 A1
(43) Pub. Date: Jul. 28, 2022

(54) LOAD FLOOR WITH ELECTRONIC COMPONENTS

(71) Applicant: ABC TECHNOLOGIES INC., Toronto, ON (CA)

(72) Inventors: Avinash JAYAKUMAR, Mississauga (CA); Harman GILL, Brampton (CA); Usman DULATOV, Newmarket (CA); Sean SANJABI, Richmond Hill (CA)

(21) Appl. No.: 17/614,036

(22) PCT Filed: May 29, 2020
(86) PCT No.: PCT/CA2020/050733

§ 371 Date: Nov. 24, 2021

Related U.S. Application Data
(60) Provisional application No. 62/855,529, filed on May 31, 2019.
(60) Provisional application No. 62/860,064, filed on Jun. 11, 2019.

(51) Int. Cl. B60R 13/01; B60Q 3/51; B60Q 3/30; B32B 3/12; B32B 29/02

(52) U.S. Cl. CPC B60R 13/011; B60Q 3/51; B60Q 3/30; B32B 3/12; B32B 29/02; B32B 2260/021; B32B 2262/106; B32B 2250/05; B32B 2605/003; B32B 2457/00; B32B 2307/412; B60R 2013/016

(57) ABSTRACT

A load floor assembly for a motor vehicle. The load floor assembly comprises a structural core, a first surface layer situated on a first side of the structural core, and a second surface layer situated on a second side of the structural core. The load floor assembly also includes an embedded layer positioned intermediate at least one of the first and second surface layers and the structural core. At least one electronic component is incorporated into the embedded layer, to provide a secondary functionality to the load floor assembly.

### FIELD OF THE INVENTION

The present invention generally relates to the field of automotive interior structures, and in particular to an automotive load floor assembly incorporating electronic features.

### BACKGROUND OF THE INVENTION

The load floor is traditionally intended to serve as a stable planar platform upon which cargo of varying sizes and weights may be placed. Improvements on load floors have led to a variety of construction types, including but not limited to injection molding, blow molding, compression molding as well as thermoforming. The selection of materials has also led to improvements with respect to the general weight to strength profile, in particular through the use of modern materials such as glass fiber, and honeycomb panels to provide structural integrity to the load floor construct.

The manner of usage of the automobile is rapidly changing, with autonomous vehicles and increased ride sharing configurations being presented to the market. With these changes, the manner by which vehicle users and occupants interface with the vehicle is rapidly changing. While the market is beginning to witness the introduction of enhanced user interfaces within the vehicle interior to present a more sophisticated user experience, there has been little to no development in respect of electronic cargo management solutions. There is clearly a need in the industry to present a modernized cargo management experience, that takes advantage of today's electronic technology.

### SUMMARY OF THE INVENTION

According to an aspect of an embodiment, provided is a load floor assembly for a motor vehicle. The load floor assembly comprises a structural core, a first surface layer situated on a first side of the structural core, and a second surface layer situated on a second side of the structural core. The load floor assembly also includes an embedded layer positioned intermediate at least one of the first and second surface layers and the structural core. At least one electronic component is incorporated into the embedded layer, to provide a secondary functionality to the load floor assembly.

### BRIEF DESCRIPTION OF THE DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1a is a perspective view of an exemplary load floor assembly in accordance with an embodiment hereof, showing the incorporation of a lighting feature, and wherein the lighting feature is showing a first illuminated message.

FIG. 1b is a perspective view of the load floor assembly according to FIG. 1, showing a second illuminated message.

FIG. 2 is a perspective view of the load floor assembly according to FIG. 1, shown positioned in a rear compartment of a vehicle.

FIG. 3 is an exploded view of a load floor assembly.

FIG. 4 is a schematic sectional view of the load floor assembly according to FIG. 3.

### DETAILED DESCRIPTION OF EMBODIMENTS

Specific embodiments of the present invention will now be described with reference to the Figures, wherein like reference numbers indicate identical or functionally similar elements. The following detailed description is merely exemplary in nature and is not intended to limit the invention or the application and uses of the invention. A person skilled in the relevant art will recognize that other configurations and arrangements can be used without departing from the scope of the invention. Although the description and drawings of the embodiments hereof exemplify the technology as applied to automotive load floors, the invention may be applied in other automotive applications. The technology may also find application outside the automotive field, for example in the aerospace sector. Furthermore, there is no intention to be bound by any expressed or implied theory presented in the preceding technical field, brief summary or the following detailed description.

### GENERAL

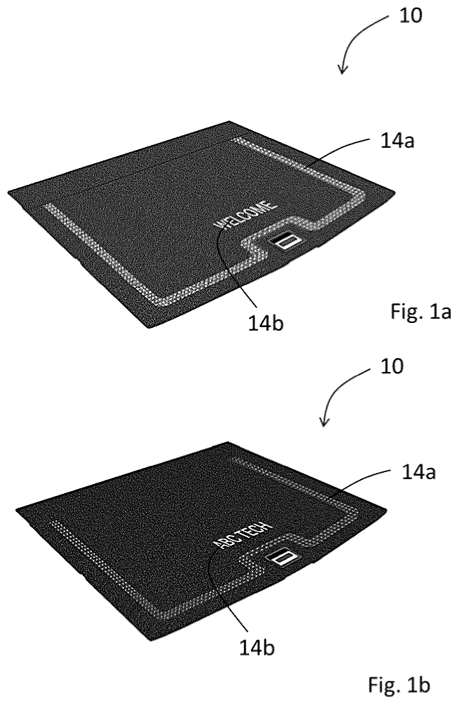

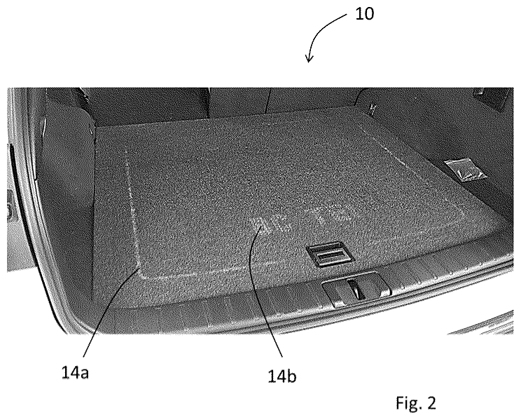

Turning now to FIGS. 1a, 1i and 2, shown is an exemplary load floor assembly 10 for a motor vehicle, incorporating electronic components 14.

As stated previously, the load floor is traditionally intended to serve as a stable planar platform upon which cargo of varying sizes and weights may be placed. The load floor assembly 10 detailed herein is an improvement upon this, in that it is configured to provide additional functionality, through the incorporation of electronic components added and/or embedded into the construction.

In some embodiments, the load floor assembly 10 may include lighting components to provide a visually aesthetic user interface, for example a communication display board to communicate messages and/or numbers to the user. The load floor assembly 10 shown in FIGS. 1a through 2 exemplifies this arrangement, with the provision of a peripheral light band 14a and an illuminated communication display board 14b provided.

In some embodiments, the load floor assembly 10 may include sensors that enable the detection and/or determination of weight of cargo placed upon it. For example, sensors may be used to detect and alert vehicle occupants/operators to cargo that may be accidentally left behind in ride-share or taxi vehicles. The incorporation of sensors may also be useful in the logistics industry, as it would provide the logistics/delivery hub with the ability to acquire real time data regarding cargo capacity usage, delivery and general cargo management.

In some embodiments, the load floor assembly 10 may contain speakers and/or transducers to detect vehicle/cargo occupancy, and provide means to communicate information or alerts. For example, the addition of these components may assist in identifying the location of desired cargo when several load floor assemblies are placed adjacent to each other, and/or to serve as a location guidance feature for visually impaired individuals to access their cargo. These components may also be used to manage noise.

In some embodiments, the load floor assembly 10 may include embedded electronically controlled temperature regulating components that serve to supply and/or remove heat from cargo placed upon the load floor assembly. For example, embedded heating or cooling components may be used to aid the preservation of thermally sensitive cargo such as medicines, food, produce, etc.

In some embodiments, the load floor assembly 10 may be removeable from the vehicle, and therein configured with the appropriate connectors to enable the load floor assembly 10 to be serviced and/or calibrated as necessary for the intended function.

### CONSTRUCTION

The load floor assembly 10 is formed as a lightweight construction with a structural core made of honeycomb paper, foam or other suitable material. Situated on or proximal each of the top and bottom surfaces of the structural core (the A and B sides, respectively), there is provided a respective skin or surface layer made of recycled carbon fiber, glass fiber, thermoplastic sheets, or other suitable materials for lightweight constructions. The skin or surface layer may be formed to present a textile fabric finish on the exposed side, or may be configured to receive an additional aesthetic covering to present the desired aesthetic look and feel.

In the discussion that follows, provided is one exemplary construction for the load floor assembly 10. It will be appreciated that other constructions are possible and are intended to fall within the scope of the claimed invention.

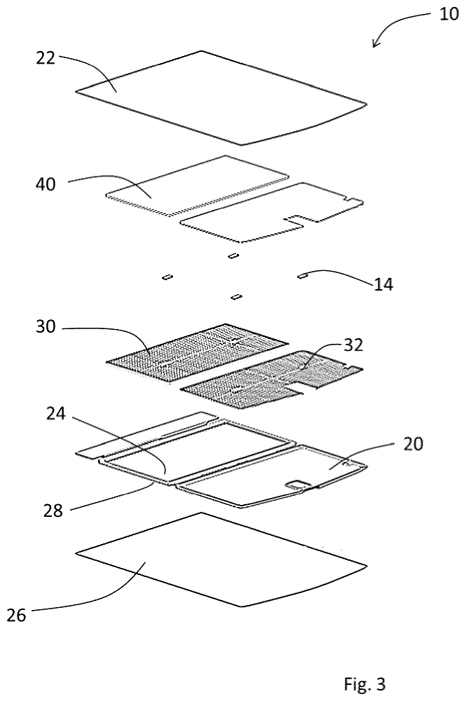

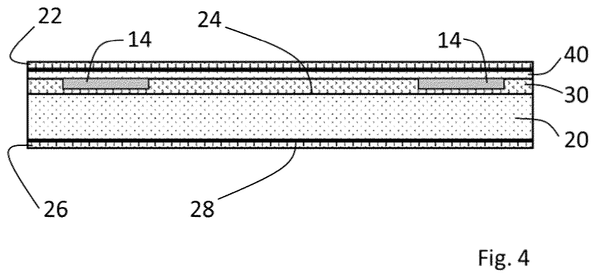

With reference now to FIG. 3 and the schematic representation of FIG. 4 shown is an exemplary load floor assembly 10. The assembly 10 includes a structural core 20, a first surface layer 22 situated on a first side 24 of the structural core 20, and a second surface layer 26 applied to a second side 28 of the structural core 20. The first and second surface layers 22, 26 are presented in the form of respective first and second fiber layers 22, 26. The assembly 10 also provides a curable matrix wetted (incorporated) into each of the first and second fiber layers 22, 26. The curable matrix is generally a thermoset or thermoplastic polymer.

A range of materials may be utilized for the structural core 20. In a preferred embodiment, the structural core 20 is a honeycomb paperboard. The honeycomb paperboard may be manufactured from either recycled or virgin paper, although honeycomb paperboard based on recycled paper is preferred. The honeycomb paperboard may have a thickness ranging from 3 to 25 mm. Specific thicknesses contemplated include 3 mm, 5 mm, 10 mm, 15 mm, 20 mm, and 25 mm. It will be appreciated that thicknesses both above and below this range, as well as between the specific values noted above may also be suitably implemented. The honeycomb paperboard may have a cell size ranging from 4 to 15 mm. Specific cell sizes contemplated include 4 mm, 6 mm, 8 mm, 10 mm, 12 mm, and 15 mm. It will be appreciated that cell sizes both above and below this range, as well as between the specific values noted above may also be suitably implemented. The honeycomb paperboard may have a density ranging from 100 to 600 g/m². Specific densities contemplated include 100 g/m², 120 g/m², 140 g/m², 180 g/m², 200 g/m², 220 g/m², 260 g/m², 300 g/m², 450 g/m², and 600 g/m². It will be appreciated that densities both above and below this range, as well as between the specific values noted above may also be suitably implemented.

It will be appreciated that the structural core 20 may be selected from a range of alternate substrates including, but not limited to expanded paperboard, wave-core paperboard, as well as plastic and metallic (i.e., aluminum) based honeycomb board. It will be appreciated that the use of a honeycomb structural core is merely exemplary, as other non-honeycomb constructs for the structural core 20 are possible. For example, the structural core 20 may be formed using a variety of other manufacturing processes including, but not limited to injection molding, blow molding, compression molding, thermoforming, as well as various machining processes. A specific example of an alternative load floor construct that may find application for the structural core is found in U.S. Pat. No. 9,174,382, the contents of which are herein incorporated by reference. Another alternative load floor construct that may find application for the structural core is found in U.S. patent application Ser. No. 14/123,574, the contents of which are herein incorporated by reference. In some embodiments, the structural core 20 may be formed from multiple layers sandwiched together to form a composite core board. In addition, the structural core may also contain reinforcement members to provide additional strength and localized reinforcement, as deemed necessary for the intended purpose.

The first and second fiber layer 22, 26 may be selected from a range of materials. In a first embodiment, the first and second fiber layer 22, 26 are formed from virgin or recycled carbon fiber, or a combination thereof. In another embodiment, the first and second fiber layers 22, 26 are formed from natural fiber. In a further embodiment, the first and second fiber layers 22, 26 are formed from glass fiber. In yet another embodiment, the first and second fiber layers 22, 26 are a blended mat having two or more of natural fiber, virgin or recycled carbon fiber, and glass fiber. Natural fibers may be selected from a range of natural fibers including but not limited to kenaf, hemp, flax, coconut or coir, sisal, jute, and mixtures thereof. Both virgin and recycled carbon fiber are available commercially. For example, chopped reclaimed carbon fiber is available through Carbon Conversions of Lake City, S.C. Where the first and second fiber layers 22, 26 are formed from a blended recycled carbon fiber/natural fiber, the amount of recycled carbon fiber in the blended mat may range from 5% to 50% (w/w RCF to NF), with specific quantities contemplated including 5%, 7%, 15%, 17% 25%, 35% and 50% (w/w). It will be appreciated that quantities of recycled carbon fiber both above and below this range, as well as between the specific values noted above may also be suitably implemented.

In some embodiments, a synthetic fiber may be substituted for the natural fiber component in the blended mat. In other embodiments, the synthetic fiber may constitute a third component in the natural fiber/recycled carbon fiber blended mat. Suitable synthetic fibers may include but are not limited to polymeric fibers such as Kevlar or aramid fibers, mineral fibers, glass fibers or mixtures thereof.

The first and second fiber layer 22, 26 may be provided in a variety of forms, including but not limited to woven and non-woven mats. In a preferred embodiment, the first and second fiber layer 22, 26 are a non-woven mat, for example as produced through a wetlaid process. It will be appreciated, however, that a variety of manufacturing methods for both non-woven and woven mats are known and will not be detailed herein. In general, each of the first and second fiber layer 22, 26 includes the natural fiber and recycled carbon fiber in a uniformly dispersed arrangement within the mat, thereby exhibiting consistency with respect to both performance characteristics and matrix wetting during manufacture of the assembly 10. The first and second layer 22, 26 may each have a mat density in the range of 100 to 400 g/m². Specific mat densities contemplated include 140 g/m², 180 g/m², 200 g/m², 220 g/m², 260 g/m², and 300 g/m². It will be appreciated that mat densities both above and below this range, as well as between the noted values may find application in certain embodiments.

The curable matrix may be selected from both thermoset and thermoplastic polymers. In a preferred embodiment, the curable matrix is a thermoset resin such as polyurethane. The polyurethane may be formulated in a variety of ways as generally known in the art to produce a rigid or semi-rigid matrix once cured. The polyol component of the polyurethane may be derived from petroleum or bio-based sources or may consist of a combination thereof. In applying the curable matrix to the first and second layer 22, 26, a weight coverage of 300 to 1200 g/m² is selected. It will be appreciated however that weight coverage both above and below this range may be implemented in certain embodiments.

The determination of material and manufacturing process for the first and second layers 22, 26 will be selected based on the intended final configuration of the load floor assembly 10. Where the electronic components 14 to be incorporated require a transmissive quality in the first layer 22, as would be the case for a lighting feature, the choice of materials and manufacturing process will be selected based on achieving a layer that permits for a desired transmission of light therethrough. Alternatively, where the electronic components 14 to be incorporated are intended to measure and provide data on cargo weight and distribution, the choice of materials and manufacturing process will be selected based on achieving a layer that permits for accurate weight sensor measurements. Still further, where the electronic components 14 to be incorporated are intended to provide a sound/alerting function, the choice of materials and manufacturing process will be selected based on achieving a layer that permits for an acoustical function (both transmission and absorption, depending on the desired performance characteristics).

Continuing with FIGS. 3 and 4, intermediate the structural core 20 and the first mat 22, the assembly 10 provides an embedded layer 30. It is within the embedded layer 30 that the selected electronic components 14 are mounted, based on the intended additional functionality of the load floor assembly 10. The embedded layer 30 may be a woven or non-woven mat, or may be presented in the form of a thermoplastic sheet. The embedded layer 30 will provide cut-outs or receptacles 32 that receive and support the electronic components 14, and may also provide conduits, channels, wiring or other means to electrically connect the components to a power source and/or control system (not shown). The embedded layer 30 may be adhesively bonded to the structural core 20, or may be set in a curable matrix that bonds to the structural core 20 during the manufacturing process. The embedded layer 30 may also be selected from a compressible material that permits for sufficient compression to enable load detection at any sensors placed therein. Where the electronic components 14 are provided as lighting or electronically controlled temperature regulating components, the embedded layer 30 may be formed of a material that enhances the intended functionality of the embedded component. For instance, when the electronic component 14 is provided in the form of a lighting component, the embedded layer 30 may include a light reflective coating or film that enhances the transmission of light in accordance with the desired effect. Similarly, where the electronic component 14 is provided in the form of a temperature regulating component, the embedded layer 30 may include a temperature reflective coating or film to direct the heat/cold in the desired manner (i.e. in the direction of the surface upon which the cargo is carried). It will be appreciated that the embedded layer 30 may take on a variety of forms, to achieve the desired functionality, and it is therefore not intended to be limited in shape, structure and/or material composition in any way.

In some embodiments, the load floor assembly 10 may additionally include a transmissive layer 40 intermediate the embedded layer 30 and the first layer 22. The transmissive layer 40 may provide additional protection to the electronic components 14 incorporated into the construction, or may serve to enhance the desired effect of the functional attributes achieved by the electronic components 14. Where the electronic components 14 are provided as lighting elements, the transmissive layer 40 may serve to direct the light to the first layer 22 with minimal light dispersion, to increase overall brightness and clarity.

The load floor assembly 10 is intended to receive a variety of electronic components 14, to achieve a variety of secondary functionalities. As previously stated, the electronic components 14 may be selected from lighting components, sensors, speakers/transducers, and temperature regulating components. It will be appreciated, however, that a wide variety of electrical components may be suitably implemented in the construction of the load floor assembly 10, and that the listing provided above is merely exemplary for the purpose of discussion.

For the exemplary listing of electronic components listed above, additional details with respect to the type and form of these electronic components is presented as follows:
Lighting Components—Exemplary lighting components include, but are not limited to LEDs, light guides, light films, and other luminous sources;
Sensors—Exemplary sensors include, but are not limited to load sensing equipment, strain gauges, load cells, force sensitive resistors, and other similar force sensing transducers (load sensing transducers);
Speakers/Transducers—Exemplary sensors include, but are not limited to speakers, microphones, and other acoustic equipment;
Temperature Regulating Components—Exemplary sensors include, but are not limited to cooling/heating pads, coils, films, foils, and other means to impart a thermal change.

It will be appreciated that in any load floor assembly 10, the selection of electronic components will be a function of the intended secondary functionality, and further that the load floor assembly 10 may include more than one type of electronic component for multiple secondary functions (i.e. cargo detection and lighting). The number of electronic components embedded of one particular type will be determined based on the desired performance, and further that multiple types of components may be used to achieve a certain functionality, such as combining strain gauges and load cells to enable both weight sensing and weight determination.

It will be appreciated that the placement of the electronic components as shown in the figures is merely exemplary, and that their placement within the embedded layer 30 will be selected based on the specifics of the components in question. In certain instances, the placement of the components will be selected based on a desired aesthetic character, as would be the case with various light emanating fixtures. In other instances, the placement of the components will be based on the optimal location for the component to detect/measure the character in question (i.e. weight as determined by load sensors). For any electronic component to be incorporated into the load floor assembly, the entire area of the embedded layer is considered available, with the specific location being selected based on the operational specifics for the component in question.

For each of the above exemplary electronic components, the load floor assembly 10 may additionally comprise electronic controller(s) that enable the desired functionality. The load floor assembly 10 may also include connectors that permit for connection to an internal power source, or a power source that is provided external to the load floor assembly 10. Connectors may also be provided to permit the bi-directional transmission of data from the load floor assembly to the vehicle. The connections may be made with standard interfaces including CAN, USB, or other appropriate standards. The connections for the load floor may also be made through physical contacts located on the B-side of the load floor assembly. Exemplary physical contacts include, but are not limited to—
male pins that insert and electrically communicate with a corresponding female interface feature on the vehicle (i.e. on the fixed frame of the vehicle),
female sockets that interface and electrically communicate with a corresponding male interface feature on the vehicle (i.e. on the fixed frame of the vehicle),
one or more contact pads that contact and electrically communicate with corresponding contact surfaces on the vehicle (i.e. on the fixed frame of the vehicle)
wired end connectors that connect and electrically communicate with corresponding connectors provided on the vehicle.

The various physical contacts mentioned above may additionally be facilitated through the use of magnetic components that allow for the load floor to be self-locating, or self-aligning when being re-installed into the vehicle.

In some embodiments, the power and data transmission connections to the vehicle and remote locations may be made through wireless means, such as Bluetooth, WiFi, or other appropriate technologies.

Regardless of the method by which the electronic components are configured to electrically communicate, the intended effect is the communication of data to a data collection system located on-board the vehicle, or to a remote location for further processing. Based on the processed data, the behaviour, performance and/or functionality of the vehicle in respect of the aspects being monitored by the load floor assembly can be modified and/or tailored in accordance with a chosen set of instructions.

While not specifically detailed, the load floor assembly 10 may additionally comprise hardware including but not limited to securement hooks, handles, hinges, and locks.

While the load floor assembly has been exemplified as having the embedded layer 30 intermediate the first layer 22 and the structural core 20, in some embodiments, the embedded layer 30 may be intermediate the structural core 20 and the second layer 26, that is on the lower side (the B-side) of the load floor assembly 10. In some embodiments, an embedded layer 30 may be provided on both the A and B-sides of the load floor assembly 10, therein placing the associated electronic components both above and below the structural core 20, based on the intended functionality, and suitability of those components at the selected location in the assembly.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments but should be defined only in accordance with the appended claims and their equivalents. It will also be understood that each feature of each embodiment discussed herein, and of each reference cited herein, can be used in combination with the features of any other combination. All patents and publications discussed herein are incorporated by reference herein in their entirety.

What is claimed is:

1. A load floor assembly for a motor vehicle, the load floor assembly comprising,
a structural core,
a first surface layer situated on a first side of the structural core,
a second surface layer situated on a second side of the structural core,
an embedded layer positioned intermediate at least one of the first and second surface layers and the structural core
wherein at least one electronic component is incorporated into the embedded layer, to provide a secondary functionality to the load floor assembly.

2. The load floor assembly according to claim 1, wherein the embedded layer is positioned intermediate the structural core and the first surface layer.

3. The load floor assembly according to claim 2, further comprising a transmissive layer positioned intermediate the embedded layer and the first surface layer.

4. The load floor assembly according to claim 1, wherein the embedded layer contains more than one type of electronic component, to provide more than one type of secondary functionality to the load floor assembly.

5. The load floor assembly according to claim 1, wherein the structural core is formed from a honeycomb paperboard.

6. The load floor assembly according to claim 1, wherein each of the first and second surface layers are presented in the form of respective first and second fiber layers.

7. The load floor assembly according to claim 6, wherein each of the first and second fiber layers is formed from carbon fiber.

8. The load floor assembly according to claim 7, wherein the carbon fiber is recycled.

9. The load floor assembly according to claim 1, wherein the electronic components are presented in the form of lighting components.

10. The load floor assembly according to claim 1, wherein the electronic components are presented in the form of sensors to detect and/or measure the weight of cargo items placed upon the load floor assembly.

11. The load floor assembly according to claim 1, wherein the electronic components are presented in the form of speakers and/or transducers.

12. The load floor assembly according to claim 1, wherein the electronic components are presented in the form of temperature regulating components.

13. The load floor assembly according to claim 1, further comprising one or more connectors to connect the assembly to one or more of external power supplies and controllers.

14. The load floor assembly according to claim 1, wherein the electronic components are arranged to be capable of wireless power and data transmission to an external data collection system.
